(19) United States
(12) Patent Application Publication
(10) Pub. No.: US 2025/0031145 A1
(43) Pub. Date: Jan. 23, 2025

(54) ACTIVATING A SLEEP MODE AT A USER EQUIPMENT

(71) Applicant: QUALCOMM Incorporated, San Diego, CA (US)

(72) Inventors: Anindya GUPTA, Bangalore (IN); Naveen Kumar BELLAMKONDA, Hyderabad (IN); Vivek Kumar RANGAMGARI, Bangalore (IN); Lokesh Sundaramurthy SATRASALA, Bangalore (IN); Abhinay RamRaj DEEVI, Guntur (IN); Gowrisankar SOMICHETTY, Bangalore (IN); Ashutosh Vinod AGRAWAL, Bengaluru (IN); Manav LNU, Hyderabad (IN); Pooja SHARMA, Gadarwara (IN); Bhanu Hamsa Prasada Viswa Bharat PEDDINTI, Hyderabad (IN); Venkata Pavan Kumar Bhargav MEDEPALLY, Hyderabad (IN); Ravi Kishore PARUCHURU, Hyderabad (IN); Satish Kumar SINGH, Hyderabad (IN)

(21) Appl. No.: 18/713,867

(22) PCT Filed: Jan. 12, 2023
(86) PCT No.: PCT/US2023/060540

§ 371 Date: May 28, 2024

(30) Foreign Application Priority Data
Jan. 28, 2022 (IN) 202241004806

(51) Int. Cl. H04W 52/02; H04L 5/00; H04W 72/1273

(52) U.S. Cl. CPC H04W 52/0206; H04L 5/0053; H04W 72/1273

(57) ABSTRACT

Various aspects of the present disclosure generally relate to wireless communication. In some aspects, a user equipment (UE) may receive, from a network node, one or more control channel symbols in a subframe. The UE may activate a sleep mode for the subframe irrespective of a control channel decoding result associated with the one or more control channel symbols, wherein the control channel decoding result is associated with a presence or an absence of a downlink shared channel grant. Numerous other aspects are described.

### CROSS-REFERENCE TO RELATED APPLICATION

This patent application claims priority to Indian Nonprovisional patent application No. 202241004806, filed on Jan. 28, 2022, entitled “ACTIVATING A SLEEP MODE AT A USER EQUIPMENT,” which is hereby expressly incorporated by reference herein.

### FIELD OF THE DISCLOSURE

Aspects of the present disclosure generally relate to wireless communication and to techniques and apparatuses for activating a sleep mode at a user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network node, one or more control channel symbols in a subframe; and activate a sleep mode for the subframe irrespective of a control channel decoding result associated with the one or more control channel symbols, wherein the control channel decoding result is associated with a presence or an absence of a downlink shared channel grant.

In some implementations, a method of wireless communication performed by a UE includes receiving, from a network node, one or more control channel symbols in a subframe; and activating a sleep mode for the subframe irrespective of a control channel decoding result associated with the one or more control channel symbols, wherein the control channel decoding result is associated with a presence or an absence of a downlink shared channel grant.

In some implementations, a non-transitory computer-readable medium storing a set of instructions for wireless communication includes one or more instructions that, when executed by one or more processors of a UE, cause the UE to: receive, from a network node, one or more control channel symbols in a subframe; and activate a sleep mode for the subframe irrespective of a control channel decoding result associated with the one or more control channel symbols, wherein the control channel decoding result is associated with a presence or an absence of a downlink shared channel grant.

In some implementations, an apparatus for wireless communication includes means for receiving, from a network node, one or more control channel symbols in a subframe; and means for activating a sleep mode for the subframe irrespective of a control channel decoding result associated with the one or more control channel symbols, wherein the control channel decoding result is associated with a presence or an absence of a downlink shared channel grant.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a sleep mode, in accordance with the present disclosure.

FIGS. 4-7 are diagrams illustrating examples associated with activating a sleep mode at a UE, in accordance with the present disclosure.

FIG. 8 is a diagram illustrating an example process associated with activating a sleep mode at a UE, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

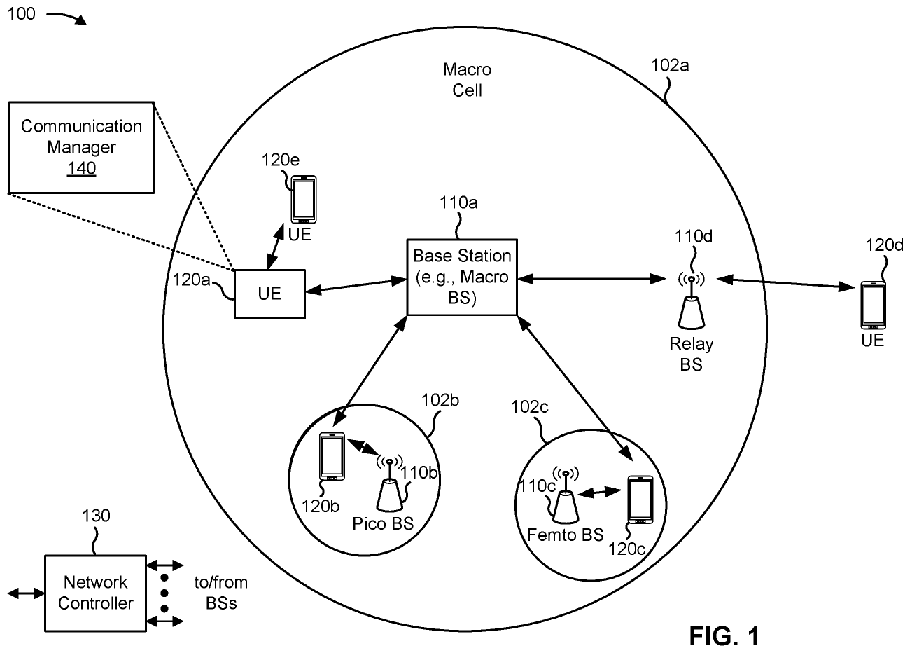

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120c), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, one or more control channel symbols in a subframe; and activate a sleep mode for the subframe irrespective of a control channel decoding result associated with the one or more control channel symbols, wherein the control channel decoding result is associated with a presence or an absence of a downlink shared channel grant. Additionally, or alternatively, the communication manager 140 may perform one or more other operations described herein.

As indicated above, FIG. 1 is provided as an example. Other examples may differ from what is described with regard to FIG. 1.

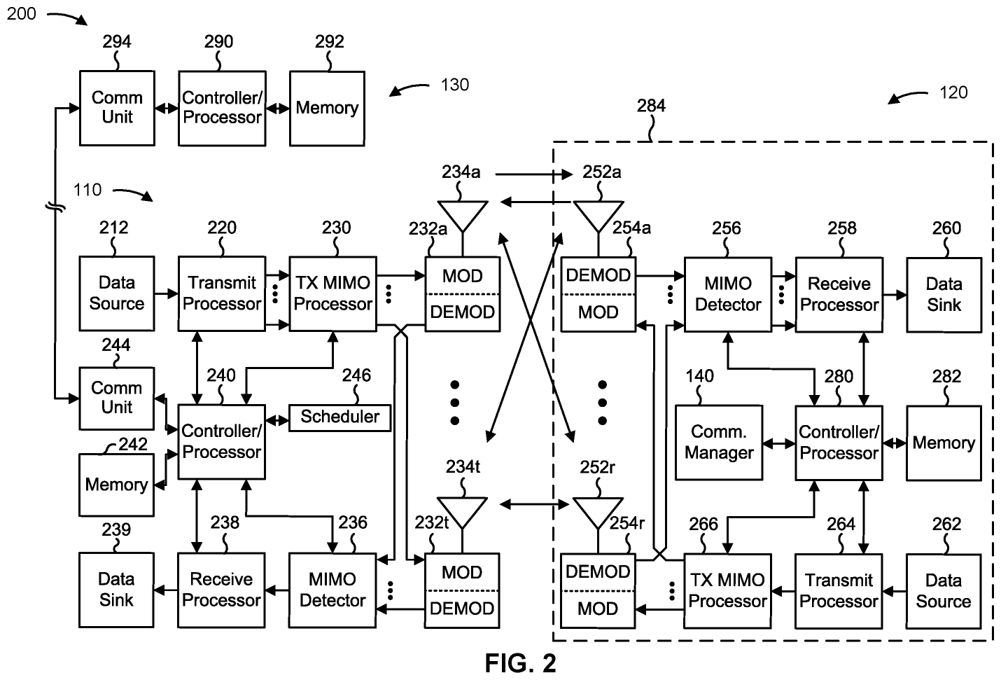

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

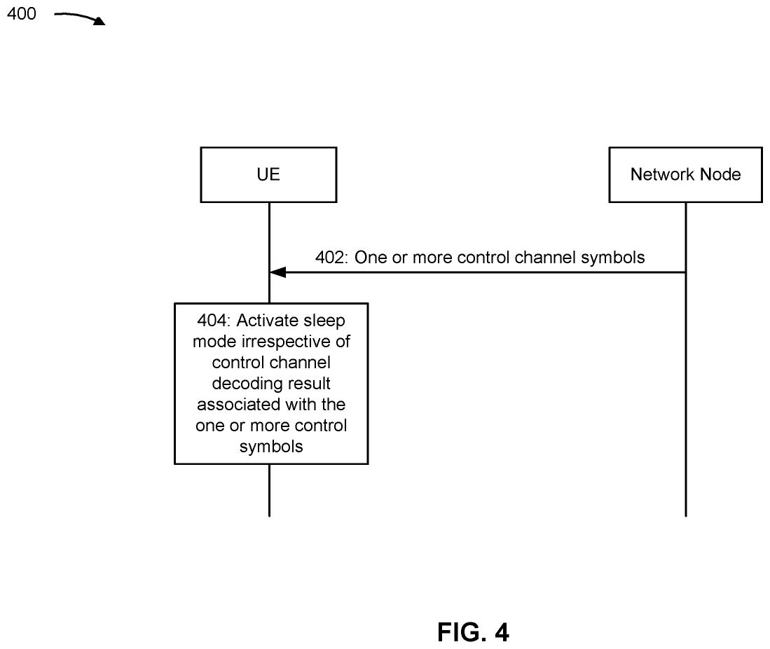

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

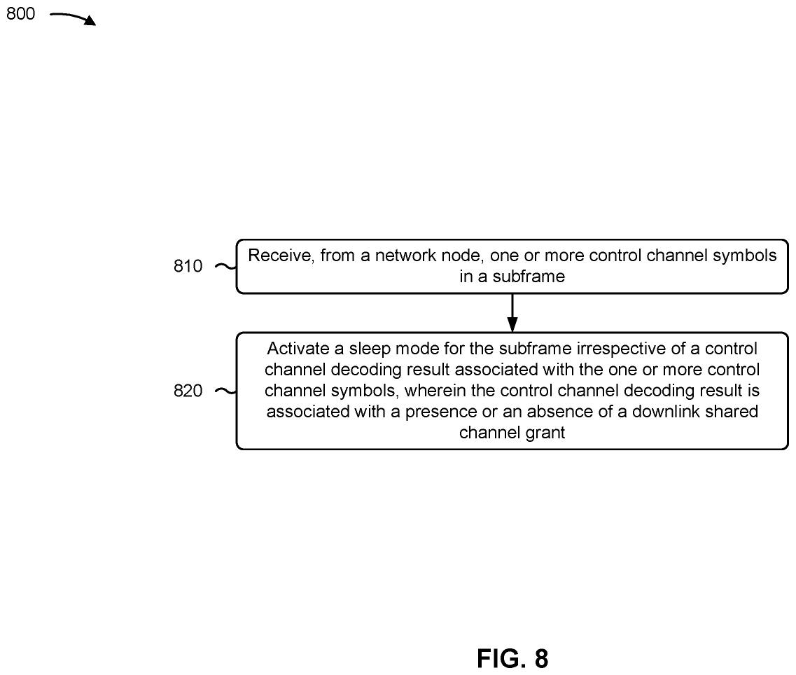

The controller/processor 240 of the base station 110, the controller/processor 280 of the UE 120, and/or any other component(s) of FIG. 2 may perform one or more techniques associated with activating a sleep mode at a UE, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node, one or more control channel symbols in a subframe; and/or means for activating a sleep mode for the subframe irrespective of a control channel decoding result associated with the one or more control channel symbols, wherein the control channel decoding result is associated with a presence or an absence of a downlink shared channel grant. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

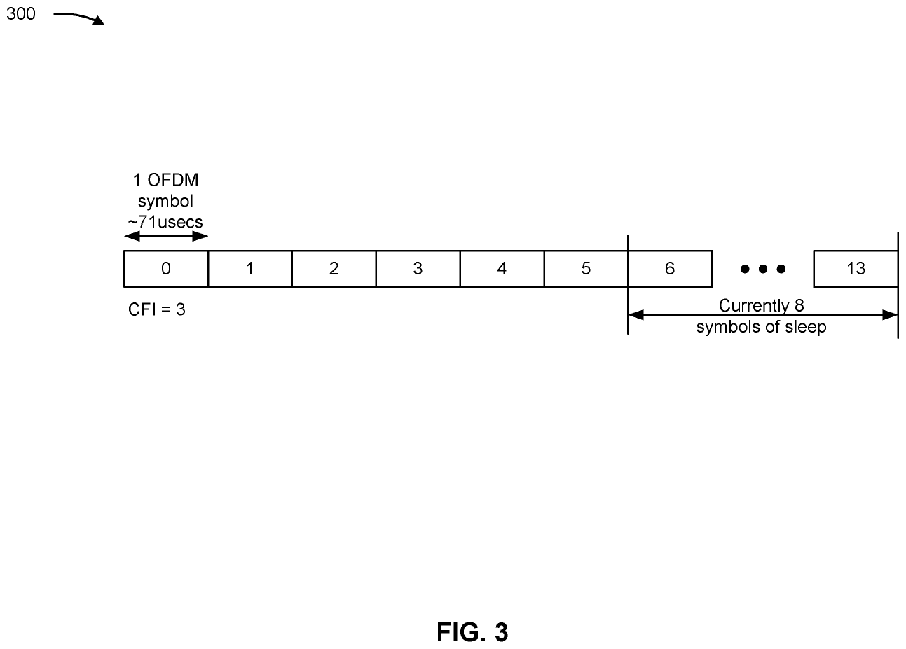

FIG. 3 is a diagram illustrating an example 300 of a sleep mode, in accordance with the present disclosure.

A UE may receive a quantity of control channel symbols in a subframe. The control channel symbols may be OFDM symbols. The control channel symbols may be associated with a downlink control channel, such as a physical downlink control channel (PDCCH). The quantity of control channel symbols may be first symbols in the subframe (e.g., the first three symbols of the subframe). The quantity of control channel symbols may depend on a control format indicator (CFI). The UE may decode the quantity of control channel symbols associated with the PDCCH by decoding a physical control format indicator channel (PCFICH), and the UE may enter a sleep mode (or low power mode) after a PDCCH decode result is available. The UE may enter the sleep mode by inactivating a receiver of the UE. For example, after the PDCCH decode result indicates that no downlink shared channel grant, such as a physical downlink shared channel (PDSCH) grant, is invoked by the PDCCH in the quantity of control channel symbols, the UE may enter the sleep mode.

As shown in FIG. 3, when the CFI is three, the UE may receive three control channel symbols in the subframe (e.g., symbol 0, symbol 1, and symbol 2). The UE may determine, from the three control channel symbols, that a PDCCH decode result indicates that no PDSCH grant is invoked by the three control channel symbols. The UE may determine to enter a sleep mode based at least in part on no PDSCH grant being invoked by the three control channel symbols. However, the UE may only be able to enter the sleep mode about 5-6 symbols from a start of the subframe, depending on the PCFICH. For example, the sleep mode may be triggered at symbol 6 after the PDCCH decode result is available. Approximately three symbols may be needed after the third symbol to enter the sleep mode, due to the UE needing to determine the PDCCH decode result. As a result, the sleep mode may only be triggered on a remaining 8-9 symbols of the subframe.

As indicated above, FIG. 3 is provided as an example. Other examples may differ from what is described with regard to FIG. 3.

In various aspects of techniques and apparatuses described herein, a UE may receive one or more control channel symbols in a subframe from a network node (e.g., a base station). The one or more control channel symbols may be associated with a PDCCH, where the PDCCH may or may not indicate a PDSCH grant in the subframe. The UE may activate a sleep mode for the subframe irrespective of a control channel decoding result associated with the one or more control channel symbols, where the control channel decoding result may indicate a presence or an absence of the PDSCH grant in the subframe. The UE may activate the sleep mode by inactivating a receiver of the UE. By not waiting to obtain the control channel decoding result, the UE may activate the sleep mode at a sooner point in time (e.g., in an earlier symbol of the subframe) as compared to previous designs, such that the UE may be able to stay in the sleep mode for a greater quantity of symbols as compared to the previous designs. An ability to stay in the sleep mode for the greater quantity of symbols may provide power savings for the UE.

In some aspects, the UE may inactivate the receiver of the UE without waiting for a PDCCH decode result. In some aspects, in a first option, the UE may detect whether a PDCCH is absent in control channel symbols of a subframe. In a first sub-option of the first option, the UE may detect whether the PDCCH is absent in the control channel symbols of the subframe based at least in part on a comparison between an average log-likelihood ratio (LLR) at PDCCH candidate locations with an average PCFICH LLR. In a second sub-option of the first option, the UE may detect whether the PDCCH is absent in the control channel symbols of the subframe based at least in part on a comparison between an average tone energy at the PDCCH candidate locations with an average pilot energy of adjacent CRS tones.

In some aspects, in a second option, the UE may determine, based at least in part on a CFI history and a PDSCH grant history, a likelihood of a PDSCH grant in an upcoming subframe and a potential CFI duration for the upcoming subframe. When the UE determines that no PDSCH grant is likely in the upcoming subframe (e.g., based at least in part on a likeliness value satisfying a threshold), the UE may stream in control channel symbols and inactivate the receiver. A quantity of control channel symbols may depend on the potential CFI duration. The UE may immediately inactivate the receiver after streaming in the control channel symbols, without detecting whether a PDCCH is absent in the control channel symbols. In the second option, the UE may avoid a wait time associated with determining that the PDCCH is absent (as in the first option).

In some aspects, in a third option, when the receiver of the UE is inactivated and the UE detects a PDSCH grant in streamed control channel symbols, the UE may reactivate the receiver within the same subframe, and the UE may attempt to decode a PDSCH associated with the PDSCH grant. The UE may initially inactivate the receiver based at least in part on a determination that the PDCCH is absent (first option) and/or that no PDSCH grant is likely (second option). However, the UE may indeed detect the PDSCH grant in the streamed control channel symbols, and the UE may reactivate the previously inactivated receiver of the UE.

FIG. 4 is a diagram illustrating an example 400 associated with activating a sleep mode at a UE, in accordance with the present disclosure. As shown in FIG. 4, example 400 includes communication between the UE (e.g., UE 120) and a network node (e.g., base station 110). In some aspects, the UE and the network node may be included in a wireless network, such as wireless network 100.

As shown by reference number 402, the UE may receive, from the network node, one or more control channel symbols in a subframe. The one or more control channel symbols may be associated with a PDCCH. A quantity associated with the one or more control channel symbols may be based at least in part on a CFI. For example, with a CFI of three, a first three symbols of the subframe may correspond to control channel symbols. The one or more control channel symbols may or may not indicate a PDSCH grant, which may occur after the one or more control channel symbols in the subframe. In other words, the PDCCH may indicate the PDSCH grant. The UE may decode the one or more control channel symbols to obtain a control channel decoding result, which may indicate a presence of the PDSCH grant in the subframe or an absence of the PDSCH grant in the subframe.

As shown by reference number 404, the UE may activate a sleep mode for the subframe irrespective of the control channel decoding result associated with the one or more control channel symbols. In other words, the UE may activate the sleep mode for the subframe without waiting to obtain the control channel decoding result. As a result, at a time at which the UE activates the sleep mode for the subframe, the UE may have not yet determined whether the PDSCH grant is present or absent in the subframe. In some aspects, the UE may activate the sleep mode for the subframe by inactivating a receiver of the UE. The sleep mode may correspond to a low power mode of the UE, during which the receiver of the UE is inactivated and does not receive downlink data from the network node.

In some aspects, the UE may detect an absence of a PDCCH in the one or more control channel symbols. The UE may activate the sleep mode based at least in part on the absence of the PDCCH in the one or more control channel symbols.

In some aspects, the UE may detect the absence of the PDCCH in the one or more control channel symbols based at least in part on a comparison of an average LLR at PDCCH candidate locations and an average PCFICH LLR. The UE may detect the absence of the PDCCH using LLRs in parallel with a decode operation performed on the one or more control channel symbols. In other words, the UE may detect the absence of the PDCCH using LLRs at approximately the same time (subject to a time difference that satisfies a threshold value) as performing the decode operation.

In some aspects, the UE may detect the absence of the PDCCH in the one or more control channel symbols based at least in part on a comparison of an average tone energy at PDCCH candidate locations and an average pilot energy of adjacent CRS tones. The UE may detect the absence of the PDCCH using tone energy in parallel with a demapper operation performed on the one or more control channel symbols. In other words, the UE may detect the absence of the PDCCH using tone energy at approximately the same time (subject to a time difference that satisfies a threshold value) as performing the demapper operation.

In some aspects, the UE may detect the absence of the PDCCH prior to a last control channel symbol to trigger the sleep mode at an earlier point in time. For example, when the CFI is three, the UE may detect the absence of the PDCCH prior to a third control channel symbol, which may allow the UE to enter the sleep mode at the earlier point in time, as opposed to the UE detecting the absence of the PDCCH after the third control channel symbol. A quantity of control channel symbols used for a reliable PDCCH absence detection may depend on a bandwidth, a cell identifier, a UE radio network temporary identifier (RNTI), a physical hybrid automatic repeat request (HARQ) indicator channel (PHICH) configuration, and/or subframe number, which may be computed at every radio resource control (RRC) reconfiguration. When CFI is three, the UE may trigger the sleep mode after one control channel symbol in the subframe, or the UE may trigger the sleep mode after three control channel symbols in the subframe.

In some aspects, the UE may determine that a likelihood of the absence of the PDSCH grant satisfies a threshold based at least in part on a PDSCH grant history associated with the UE. The UE may determine a potential CFI duration (e.g., three symbols) based at least in part on a CFI history associated with the UE. The UE may activate the sleep mode after the potential CFI duration based at least in part on the likelihood of the absence of the PDSCH grant satisfying the threshold. The UE may activate the sleep mode after the potential CFI duration without a detection of whether a PDCCH is absent in the one or more control channel symbols.

In some aspects, the UE may determine the presence of the PDSCH grant after activating the sleep mode. For example, the UE may receive the one or more control channel symbols and activate the sleep mode without waiting to determine the control channel decoding result. However, after determining the control channel decoding result, the UE may determine that the one or more control channel symbols indeed indicated the PDSCH grant. The UE may deactivate the sleep mode and activate a normal power mode within the subframe when the PDSCH grant is present. The normal power mode may be a separate mode than the sleep mode. By activating the normal power mode, the UE may activate the receiver of the UE. The UE may attempt to decode a PDSCH in the subframe associated with the PDSCH grant. In some cases, the UE may mistakenly activate the sleep mode, even when the PDSCH grant is present in the subframe. However, the UE may be able to reactivate the receiver and attempt to decode the PDSCH.

As indicated above, FIG. 4 is provided as an example. Other examples may differ from what is described with regard to FIG. 4.

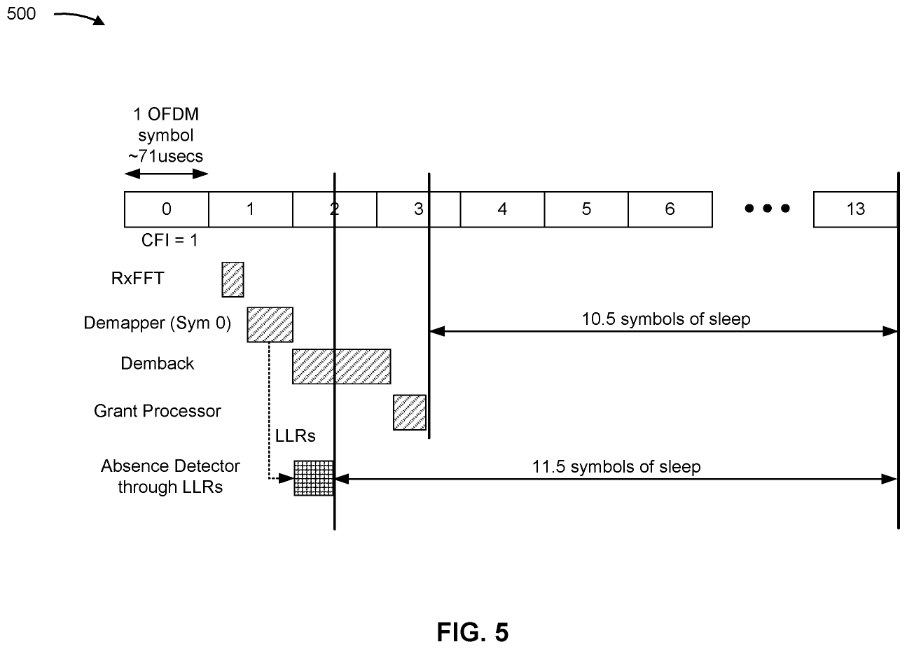

FIG. 5 is a diagram illustrating an example 500 associated with activating a sleep mode at a UE, in accordance with the present disclosure.

As shown in FIG. 5, a UE may receive one control channel symbol at symbol 0 in a subframe based at least in part on a CFI of one. The UE may perform a receive (Rx) fast Fourier transform (FFT) (RxFFT) operation and a demapper operation for the one control channel symbol. The UE may perform a demodulator backend (demback) operation to decode a PDCCH associated with the one control channel system. The UE may perform a grant processor operation to determine whether a PDSCH grant is present in the PDCCH.

In a previous design, the UE may enter a sleep mode based at least in part on the grant processor operation indicating that no PDSCH grant is present in the PDCCH. A time duration for determining that no PDSCH grant is present, from an end of the one control channel symbol, may be approximately 2.5 symbols, which may result in approximately 10.5 symbols during which the UE may be in the sleep mode.

In some aspects, in a first sub-option of a first option, as described herein, the UE may perform the decode operation in parallel with a PDCCH absence detector operation using LLRs. With the PDCCH absence detector operation, the UE may detect whether the PDCCH is absent in the one control channel symbol based at least in part on a comparison between an average LLR at PDCCH candidate locations with an average PCFICH LLR. The UE may enter the sleep mode based at least in part on an output of the PDCCH absence detector operation. The UE may inactivate a receiver of the UE when entering the sleep mode. For example, the UE may enter the sleep mode based at least in part on the PDCCH absence detector operation indicating that no PDCCH (or no PDCCH scheduling) is present in the one control channel symbol. By performing the PDCCH absence detector operation in parallel with the decode operation, the UE may potentially enter the sleep mode one symbol earlier as compared to the previous design, since the UE may not wait for a PDCCH decoding result.

In some aspects, the UE may attempt to maximize a PDCCH absence detection when the PDCCH is indeed not present. The UE may determine absolute values of control channel symbol LLRs. The UE may compute a PCFICH reference value, [symbol] [| [symbol] _{PCFICH}|], as an average of the absolute values of PCFICH LLRs. For each candidate (e.g., 22 candidates), the UE may compute an average of absolute values of LLRs of bits in that candidate. The UE may denote an average LLR of a candidate i by [symbol] [|lᵢ|], i=0, 1, . . . , 21. The UE may determine that the PDCCH is absent when not even one candidate (or average LLR of the candidate) is above a fraction of the PCFICH reference value, in accordance with Σᵢ₌₀²¹{ [symbol] [|lᵢ|]>α* [symbol] [|l_{PCFICH}|]}<1, where the parameter a may be configurable depending on an aggregation level of the candidate and the CFI.

In some aspects, with a CFI of one, implementing the first sub-option of the first option may provide approximately 80 microseconds (μs) of additional sleep, which may correspond to a power savings of 3%, as compared to the previous design. With a CFI of three, implementing the first sub-option of the first option may provide approximately 210 μs of additional sleep, which may correspond to a power savings of 8%, as compared to the previous design.

As indicated above, FIG. 5 is provided as an example. Other examples may differ from what is described with regard to FIG. 5.

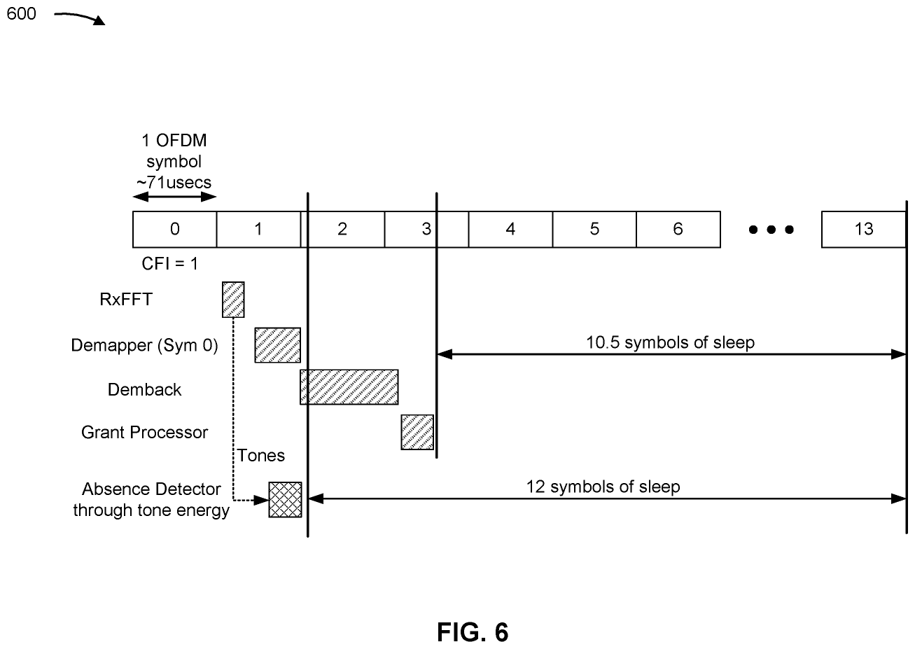

FIG. 6 is a diagram illustrating an example 600 associated with activating a sleep mode at a UE, in accordance with the present disclosure.

As shown in FIG. 6, a UE may receive one control channel symbol at symbol 0 in a subframe based at least in part on a CFI of one. The UE may perform an RxFFT operation and a demapper operation for the one control channel symbol. The UE may perform a demodulator backend operation to decode a PDCCH associated with the one control channel system. The UE may perform a grant processor operation to determine whether a PDSCH grant is present in the PDCCH.

In a previous design, the UE may enter a sleep mode based at least in part on the grant processor operation indicating that no PDSCH grant is present in the PDCCH. A time duration for determining that no PDSCH grant is present, from an end of the one control channel symbol, may be approximately 2.5 symbols, which may result in approximately 10.5 symbols during which the UE may be in the sleep mode.

In some aspects, in a second sub-option of a first option, as described herein, the UE may perform the demapper operation in parallel with a PDCCH absence detector operation using tone energy. With the PDCCH absence detector operation, the UE may detect whether the PDCCH is absent in the one control channel symbol based at least in part on a comparison between an average tone energy at the PDCCH candidate locations with an average pilot energy of adjacent CRS tones. The UE may enter the sleep mode based at least in part on an output of the PDCCH absence detector operation. For example, the UE may enter the sleep mode based at least in part on the PDCCH absence detector operation indicating that no PDCCH is present in the one control channel symbol. The UE may inactivate a receiver of the UE when entering the sleep mode. By performing the PDCCH absence detector operation in parallel with the demapper operation, the UE may potentially enter the sleep mode 1.5 symbols earlier as compared to the previous design, since the UE may not wait for a PDCCH decoding result.

In some aspects, for a tone energy-based detection, the UE may estimate a traffic to pilot ratio (TPR), which may be a ratio of data tone energy to CRS tone energy allocated at the network, using PCFICH resource element groups (REGs) from multiple subframes (SF) as,

$$= ( \frac{{Σ}_{i} {Σ}_{j} {E}_{y , PCFICH}^{i , j}}{{Σ}_{i} {Σ}_{j} {E}_{p , PCFICH}^{i , j}} ) , j = 0 , 1 , 2 , 3 , i = 0 : {N}_{train} , {N}_{train} = 50 SFs , where {E}_{y , PCFICH}^{i , i}$$

indicates a sum of data tone energies in a j^{th} PCFICH REG of i^{th} SF, and E_{p,PCFICH}^{i,j} indicates a sum of CRS tone energies in a j^{th} PCFICH REG of i^{th} SF. For each candidate in a UE-specific and common search space, the UE may compare a ratio (T_{cndt}) of a sum of data tone energies to a sum of CRS tone energies in the candidate to a TPR-dependent threshold. When T_{cndt}=

$$( \frac{{E}_{y}^{cndt}}{{E}_{p}^{cndt}} ) > K * , then the candidate may contain the PDCCH , where {T}_{cndt} indicates a test$$

metric for the candidate, E_{y}^{cndt} indicates a sum of data tone energies in the candidate, Eₚ^{cndt} indicates a sum of CRS tone energies in the candidate, and K is a programmable scaling. When a plurality of candidates (e.g., all candidates) indicate an absence of PDCCH, the UE may determine that the PDCCH is absent, and the UE may enter the sleep mode.

As indicated above, FIG. 6 is provided as an example. Other examples may differ from what is described with regard to FIG. 6.

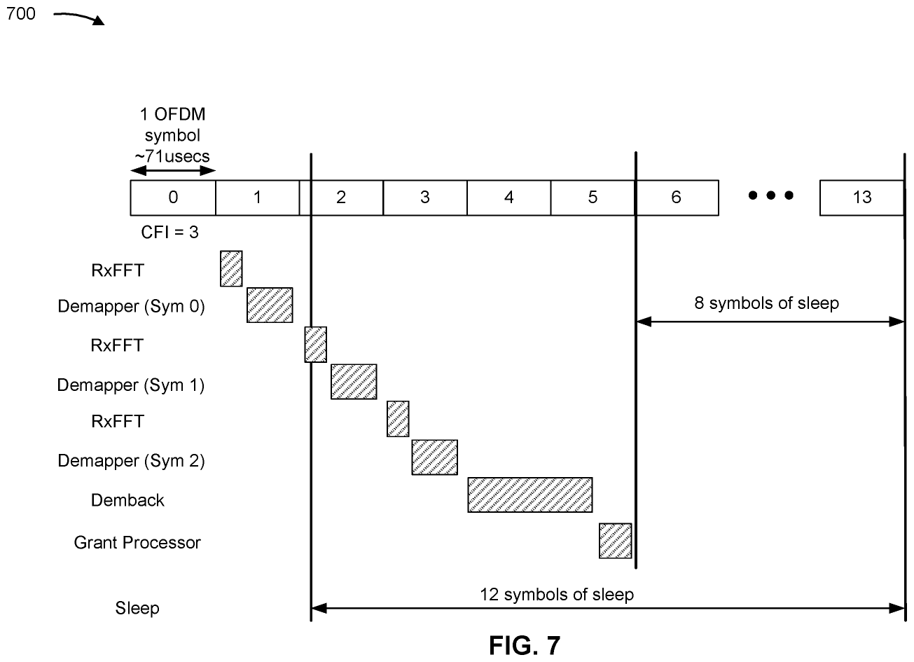

FIG. 7 is a diagram illustrating an example 700 associated with activating a sleep mode at a UE, in accordance with the present disclosure.

As shown in FIG. 7, a UE may receive one control channel symbol at symbol 0 in a subframe based at least in part on a CFI of three. The UE may perform an RxFFT operation and a demapper operation for the one control channel symbol. The UE may perform the demapper operation in parallel with a PDCCH absence detector operation using LLRs or the UE may perform the RxFFT operation in parallel with a PDCCH absence detector operation using tone energy. The UE may perform a demodulator backend operation to decode a PDCCH associated with the three control channel symbols. The UE may perform a grant processor operation to determine whether a PDSCH grant is present in the PDCCH.

In a previous design, for a CFI of three the UE may enter a sleep mode based at least in part on the grant processor operation indicating that no PDSCH grant is present in the PDCCH. A time duration for determining that no PDSCH grant is present, from an end of the last control channel symbol, may be approximately 3 symbols, which may result in approximately 8 symbols during which the UE may be in the sleep mode.

In some aspects, in a second option, as described herein, the UE may enter the sleep mode immediately after the one control channel symbol is received at the UE. The UE may determine to enter the sleep mode immediately after the one control channel symbol based at least in part on a CFI history and a PDSCH grant history. The UE may determine, based at least in part on the CFI history and the PDSCH grant history, that no PDSCH grant is likely in the subframe. For example, the UE may determine that a likelihood value satisfies a threshold, such that no PDSCH grant is likely in the upcoming subframe. The UE may stream the one control channel symbol and then enter the sleep mode, based at least in part on the determination that no PDSCH grant is likely for the subframe. The UE may inactivate a receiver of the UE when entering the sleep mode. The UE may potentially enter the sleep mode 2.5 symbols earlier as compared to the previous design, since the UE may enter the sleep mode immediately after the one control channel symbol is received at the UE.

In some aspects, the UE may implement the second option when there is no traffic for a relatively long duration, which may allow the UE to increase a sleep mode duration (e.g., a period of time in which the UE is in the sleep mode). In the second option, the UE may receive (or stream) the control channel symbols and trigger the sleep mode irrespective of a control channel decode result or control channel decode status, where the UE may receive the control channel symbols and trigger the sleep mode based at least in part on the CFI history and the PDSCH grant history. The UE may continue to perform CFI detection, control channel demapping and decoding, and other operations as background processes. The UE may exit the sleep mode (e.g., reactivate the receiver of the UE) based at least in part on a predicted CFI duration being wrong and/or the PDSCH grant being present.

In some aspects, with a CFI of one, implementing the second option may provide a power savings of 4.5%, as compared to the previous design.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with activating a sleep mode at a UE.

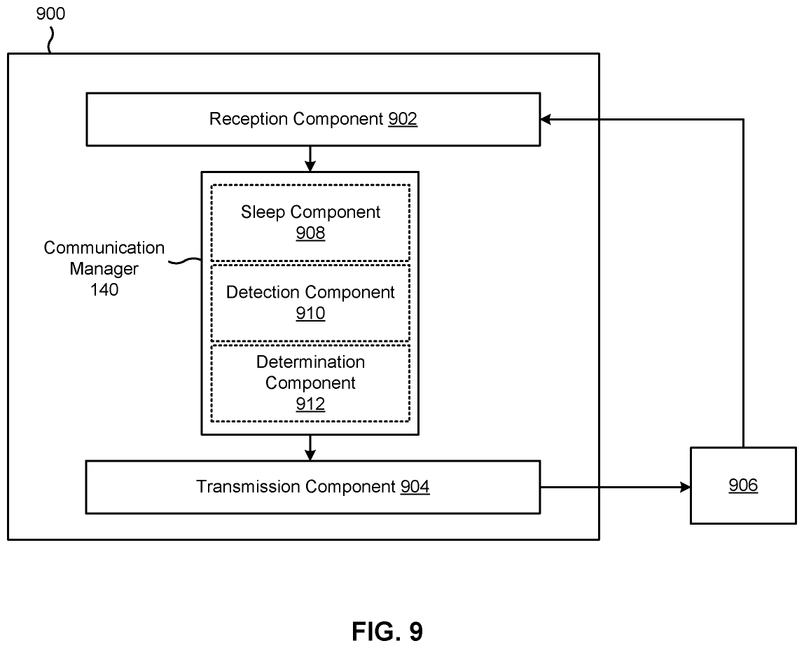

As shown in FIG. 8, in some aspects, process 800 may include receiving, from a network node, one or more control channel symbols in a subframe (block 810). For example, the UE (e.g., using communication manager 140 and/or reception component 902, depicted in FIG. 9) may receive, from a network node, one or more control channel symbols in a subframe, as described above.

As further shown in FIG. 8, in some aspects, process 800 may include activating a sleep mode for the subframe irrespective of a control channel decoding result associated with the one or more control channel symbols, wherein the control channel decoding result is associated with a presence or an absence of a downlink shared channel grant (block 820). For example, the UE (e.g., using communication manager 140 and/or sleep component 908, depicted in FIG. 9) may activate a sleep mode for the subframe irrespective of a control channel decoding result associated with the one or more control channel symbols, wherein the control channel decoding result is associated with a presence or an absence of a downlink shared channel grant, as described above.

Process 800 may include additional aspects, such as any single aspect or any combination of aspects described below and/or in connection with one or more other processes described elsewhere herein.

In a first aspect, process 800 includes inactivating a receiver of the UE.

In a second aspect, alone or in combination with the first aspect, process 800 includes detecting an absence of a downlink control channel in the one or more control channel symbols, and activating the sleep mode is based at least in part on the absence of the downlink control channel in the one or more control channel symbols.

In a third aspect, alone or in combination with one or more of the first and second aspects, detecting the absence of the downlink control channel in the one or more control channel symbols is based at least in part on a comparison of an average LLR at downlink control channel candidate locations and an average control format indicator channel LLR.

In a fourth aspect, alone or in combination with one or more of the first through third aspects, detecting the absence of the downlink control channel using LLRs is performed in parallel with a decode operation performed on the one or more control channel symbols.

In a fifth aspect, alone or in combination with one or more of the first through fourth aspects, detecting the absence of the downlink control channel in the one or more control channel symbols is based at least in part on a comparison of an average tone energy at downlink control channel candidate locations and an average pilot energy of adjacent cell-specific reference signal tones.

In a sixth aspect, alone or in combination with one or more of the first through fifth aspects, detecting the absence of the downlink control channel using tone energy is performed in parallel with a demapper operation performed on the one or more control channel symbols.

In a seventh aspect, alone or in combination with one or more of the first through sixth aspects, process 800 includes determining that a likelihood of the absence of the downlink shared channel grant satisfies a threshold based at least in part on a downlink shared channel grant history associated with the UE, and determining a potential control format indicator duration based at least in part on a control format indicator history associated with the UE, and activating the sleep mode is performed after the potential control format indicator duration based at least in part on the likelihood of the absence of the downlink shared channel grant satisfying the threshold.

In an eighth aspect, alone or in combination with one or more of the first through seventh aspects, activating the sleep mode is performed after the potential control format indicator duration without a detection of whether a downlink control channel is absent in the one or more control channel symbols.

In a ninth aspect, alone or in combination with one or more of the first through eighth aspects, process 800 includes determining the presence of the downlink shared channel grant after activating the sleep mode, deactivating the sleep mode and activating a normal power mode within the subframe based at least in part on the presence of the downlink shared channel grant, and attempting to decode a downlink shared channel associated with the downlink shared channel grant.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a sleep component 908, a detection component 910, or a determination component 912, among other examples.

In some aspects, the apparatus 900 may be configured to perform one or more operations described herein in connection with FIGS. 4-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network node, one or more control channel symbols in a subframe. The sleep component 908 may activate a sleep mode for the subframe irrespective of a control channel decoding result associated with the one or more control channel symbols, wherein the control channel decoding result is associated with a presence or an absence of a downlink shared channel grant. The sleep component 908 may inactivate a receiver of the UE.

The detection component 910 may detect an absence of a downlink control channel in the one or more control channel symbols, wherein the sleep mode is activated based at least in part on the absence of the downlink control channel in the one or more control channel symbols.

The detection component 910 may detect the absence of the downlink control channel in the one or more control channel symbols based at least in part on a comparison of an average LLR at downlink control channel candidate locations and an average control format indicator channel LLR. The detection component 910 may detect the absence of the downlink control channel using LLRs in parallel with a decode operation performed on the one or more control channel symbols.

The detection component 910 may detect the absence of the downlink control channel in the one or more control channel symbols based at least in part on a comparison of an average tone energy at downlink control channel candidate locations and an average pilot energy of adjacent cell-specific reference signal tones. The detection component 910 may detect the absence of the downlink control channel using tone energy in parallel with a demapper operation performed on the one or more control channel symbols.

The determination component 912 may determine that a likelihood of the absence of the downlink shared channel grant satisfies a threshold based at least in part on a downlink shared channel grant history associated with the UE. The determination component 912 may determine a potential control format indicator duration based at least in part on a control format indicator history associated with the UE, wherein the sleep mode is activated after the potential control format indicator duration based at least in part on the likelihood of the absence of the downlink shared channel grant satisfying the threshold. The sleep component 908 may activate the sleep mode after the potential control format indicator duration without a detection of whether a downlink control channel is absent in the one or more control channel symbols.

The determination component 912 may determine the presence of the downlink shared channel grant after activating the sleep mode. The sleep component 908 may deactivate the sleep mode and activating a normal power mode within the subframe based at least in part on the presence of the downlink shared channel grant. The reception component 902 may attempt to decode a downlink shared channel associated with the downlink shared channel grant.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving, from a network node, one or more control channel symbols in a subframe; and activating a sleep mode for the subframe irrespective of a control channel decoding result associated with the one or more control channel symbols, wherein the control channel decoding result is associated with a presence or an absence of a downlink shared channel grant.

Aspect 2: The method of Aspect 1, wherein activating the sleep mode for the subframe comprises inactivating a receiver of the UE.

Aspect 3: The method of any of Aspects 1 through 2, further comprising: detecting an absence of a downlink control channel in the one or more control channel symbols, and activating the sleep mode is based at least in part on the absence of the downlink control channel in the one or more control channel symbols.

Aspect 4: The method of Aspect 3, wherein detecting the absence of the downlink control channel in the one or more control channel symbols is based at least in part on a comparison of an average log-likelihood ratio (LLR) at downlink control channel candidate locations and an average control format indicator channel LLR.

Aspect 5: The method of Aspect 4, wherein detecting the absence of the downlink control channel using LLRs is performed in parallel with a decode operation performed on the one or more control channel symbols.

Aspect 6: The method of Aspect 3, wherein detecting the absence of the downlink control channel in the one or more control channel symbols is based at least in part on a comparison of an average tone energy at downlink control channel candidate locations and an average pilot energy of adjacent cell-specific reference signal tones.

Aspect 7: The method of Aspect 6, wherein detecting the absence of the downlink control channel using tone energy is performed in parallel with a demapper operation performed on the one or more control channel symbols.

Aspect 8: The method of any of Aspects 1 through 7, further comprising: determining that a likelihood of the absence of the downlink shared channel grant satisfies a threshold based at least in part on a downlink shared channel grant history associated with the UE; and determining a potential control format indicator duration based at least in part on a control format indicator history associated with the UE, and wherein activating the sleep mode is performed after the potential control format indicator duration based at least in part on the likelihood of the absence of the downlink shared channel grant satisfying the threshold.

Aspect 9: The method of Aspect 8, wherein activating the sleep mode is performed after the potential control format indicator duration without a detection of whether a downlink control channel is absent in the one or more control channel symbols.

Aspect 10: The method of any of Aspects 1 through 9, further comprising: determining the presence of the downlink shared channel grant after activating the sleep mode; deactivating the sleep mode and activating a normal power mode within the subframe based at least in part on the presence of the downlink shared channel grant; and attempting to decode a downlink shared channel associated with the downlink shared channel grant.

Aspect 11: An apparatus for wireless communication at a device, comprising a processor; memory coupled with the processor; and instructions stored in the memory and executable by the processor to cause the apparatus to perform the method of one or more of Aspects 1-10.

Aspect 12: A device for wireless communication, comprising a memory and one or more processors coupled to the memory, the one or more processors configured to perform the method of one or more of Aspects 1-10.

Aspect 13: An apparatus for wireless communication, comprising at least one means for performing the method of one or more of Aspects 1-10.

Aspect 14: A non-transitory computer-readable medium storing code for wireless communication, the code comprising instructions executable by a processor to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network node, one or more control channel symbols in a subframe; and
activate a sleep mode for the subframe irrespective of a control channel decoding result associated with the one or more control channel symbols, wherein the control channel decoding result is associated with a presence or an absence of a downlink shared channel grant.

2. The apparatus of claim 1, wherein the one or more processors, to activate the sleep mode for the subframe, are configured to inactivate a receiver of the UE.

3. The apparatus of claim 1, wherein the one or more processors are further configured to:
detect an absence of a downlink control channel in the one or more control channel symbols, wherein the sleep mode is activated based at least in part on the absence of the downlink control channel in the one or more control channel symbols.

4. The apparatus of claim 3, wherein the one or more processors are configured to detect the absence of the downlink control channel in the one or more control channel symbols based at least in part on a comparison of an average log-likelihood ratio (LLR) at downlink control channel candidate locations and an average control format indicator channel LLR.

5. The apparatus of claim 4, wherein the one or more processors are configured to detect the absence of the downlink control channel using LLRs in parallel with a decode operation performed on the one or more control channel symbols.

6. The apparatus of claim 3, wherein the one or more processors are configured to detect the absence of the downlink control channel in the one or more control channel symbols based at least in part on a comparison of an average tone energy at downlink control channel candidate locations and an average pilot energy of adjacent cell-specific reference signal tones.

7. The apparatus of claim 6, wherein the one or more processors are configured to detect the absence of the downlink control channel using tone energy in parallel with a demapper operation performed on the one or more control channel symbols.

8. The apparatus of claim 1, wherein the one or more processors are further configured to:
determine that a likelihood of the absence of the downlink shared channel grant satisfies a threshold based at least in part on a downlink shared channel grant history associated with the UE; and
determine a potential control format indicator duration based at least in part on a control format indicator history associated with the UE, wherein the sleep mode is activated after the potential control format indicator duration based at least in part on the likelihood of the absence of the downlink shared channel grant satisfying the threshold.

9. The apparatus of claim 8, wherein the one or more processors are configured to activate the sleep mode after the potential control format indicator duration without a detection of whether a downlink control channel is absent in the one or more control channel symbols.

10. The apparatus of claim 1, wherein the one or more processors are further configured to:
determine the presence of the downlink shared channel grant after activating the sleep mode;
deactivate the sleep mode and activate a normal power mode within the subframe based at least in part on the presence of the downlink shared channel grant; and
attempt to decode a downlink shared channel associated with the downlink shared channel grant.

11. A method of wireless communication performed by a user equipment (UE), comprising:
receiving, from a network node, one or more control channel symbols in a subframe; and
activating a sleep mode for the subframe irrespective of a control channel decoding result associated with the one or more control channel symbols, wherein the control channel decoding result is associated with a presence or an absence of a downlink shared channel grant.

12. The method of claim 11, wherein activating the sleep mode for the subframe comprises inactivating a receiver of the UE.

13. The method of claim 11, further comprising:
detecting an absence of a downlink control channel in the one or more control channel symbols, and
wherein activating the sleep mode is based at least in part on the absence of the downlink control channel in the one or more control channel symbols.

14. The method of claim 13, wherein detecting the absence of the downlink control channel in the one or more control channel symbols is based at least in part on a comparison of an average log-likelihood ratio (LLR) at downlink control channel candidate locations and an average control format indicator channel LLR.

15. The method of claim 14, wherein detecting the absence of the downlink control channel using LLRs is performed in parallel with a decode operation performed on the one or more control channel symbols.

16. The method of claim 13, wherein detecting the absence of the downlink control channel in the one or more control channel symbols is based at least in part on a comparison of an average tone energy at downlink control channel candidate locations and an average pilot energy of adjacent cell-specific reference signal tones.

17. The method of claim 16, wherein detecting the absence of the downlink control channel using tone energy is performed in parallel with a demapper operation performed on the one or more control channel symbols.

18. The method of claim 11, further comprising:
determining that a likelihood of the absence of the downlink shared channel grant satisfies a threshold based at least in part on a downlink shared channel grant history associated with the UE; and
determining a potential control format indicator duration based at least in part on a control format indicator history associated with the UE, and
wherein activating the sleep mode is performed after the potential control format indicator duration based at least in part on the likelihood of the absence of the downlink shared channel grant satisfying the threshold.

19. The method of claim 18, wherein activating the sleep mode is performed after the potential control format indicator duration without a detection of whether a downlink control channel is absent in the one or more control channel symbols.

20. The method of claim 11, further comprising:
determining the presence of the downlink shared channel grant after activating the sleep mode;
deactivating the sleep mode and activating a normal power mode within the subframe based at least in part on the presence of the downlink shared channel grant; and
attempting to decode a downlink shared channel associated with the downlink shared channel grant.

21. A non-transitory computer-readable medium storing a set of instructions for wireless communication, the set of instructions comprising:
one or more instructions that, when executed by one or more processors of a user equipment (UE), cause the UE to:
receive, from a network node, one or more control channel symbols in a subframe; and
activate a sleep mode for the subframe irrespective of a control channel decoding result associated with the one or more control channel symbols, wherein the control channel decoding result is associated with a presence or an absence of a downlink shared channel grant.

22. The non-transitory computer-readable medium of claim 21, wherein the one or more instructions, that cause the UE to activate the sleep mode for the subframe, cause the UE to inactivate a receiver of the UE.

23. The non-transitory computer-readable medium of claim 21, wherein the one or more instructions further cause the UE to:
detect an absence of a downlink control channel in the one or more control channel symbols, wherein the sleep mode is activated based at least in part on the absence of the downlink control channel in the one or more control channel symbols.

24. The non-transitory computer-readable medium of claim 21, wherein the one or more instructions further cause the UE to:
determine that a likelihood of the absence of the downlink shared channel grant satisfies a threshold based at least in part on a downlink shared channel grant history associated with the UE; and
determine a potential control format indicator duration based at least in part on a control format indicator history associated with the UE, wherein the sleep mode is activated after the potential control format indicator duration based at least in part on the likelihood of the absence of the downlink shared channel grant satisfying the threshold.

25. The non-transitory computer-readable medium of claim 21, wherein the one or more instructions further cause the UE to:
determine the presence of the downlink shared channel grant after activating the sleep mode;
deactivate the sleep mode and activating a normal power mode within the subframe; and
attempt to decode a downlink shared channel associated with the downlink shared channel grant.

26. An apparatus for wireless communication, comprising:
means for receiving, from a network node, one or more control channel symbols in a subframe; and
means for activating a sleep mode for the subframe irrespective of a control channel decoding result associated with the one or more control channel symbols, wherein the control channel decoding result is associated with a presence or an absence of a downlink shared channel grant.

27. The apparatus of claim 26, wherein the means for activating the sleep mode for the subframe comprises means for inactivating a receiver of the apparatus.

28. The apparatus of claim 26, further comprising:
means for detecting an absence of a downlink control channel in the one or more control channel symbols, and
wherein the means for activating the sleep mode is based at least in part on the absence of the downlink control channel in the one or more control channel symbols.

29. The apparatus of claim 26, further comprising:
means for determining that a likelihood of the absence of the downlink shared channel grant satisfies a threshold based at least in part on a downlink shared channel grant history associated with the apparatus; and
means for determining a potential control format indicator duration based at least in part on a control format indicator history associated with the apparatus, wherein the sleep mode is activated after the potential control format indicator duration based at least in part on the likelihood of the absence of the downlink shared channel grant satisfying the threshold.

30. The apparatus of claim 26, further comprising:
means for determining the presence of the downlink shared channel grant after activating the sleep mode;
means for deactivating the sleep mode and activating a normal power mode within the subframe; and
means for attempting to decode a downlink shared channel associated with the downlink shared channel grant.
